(19) United States
(12) Patent Application Publication
(10) Pub. No.: US 2025/0119286 A1
(43) Pub. Date: Apr. 10, 2025

(54) HOMOMORPHIC GENERATION OF ROTATION KEYS

(71) Applicant: International Business Machines Corporation, Armonk, NY (US)

(72) Inventors: Guy Moshkowich, Nes Ziyona (IL); Ramy Masalha, Kafr Qari (IL); Nir Drucker, Zichron Yaakov (IL); Allon Adir, Kiryat Tivon (IL); Eyal Kushnir, Kfar Vradim (IL)

(73) Assignee: International Business Machines Corporation, Armonk, NY (US)

(21) Appl. No.: 18/378,521

(22) Filed: Oct. 10, 2023

(51) Int. Cl. H04L 9/14; H04L 9/00

(52) U.S. Cl. CPC H04L 9/14; H04L 9/008

(57) ABSTRACT

A system for homomorphically generating rotation keys for use in homomorphic computation in association with a client, and a server coupled to the client machine over a network. Client-side code executes in the client to derive a set of Learning With Errors (LWE) ciphertexts from a secret key polynomial, the secret key polynomial having a set of coefficients. Each LWE ciphertext is derived from a coefficient of the secret key polynomial and having a single coefficient. The client-side code transmits the set of LWE ciphertexts to the server. Server-side code receives the set of LWE ciphertexts and processes them into a ring variant (R-LWE) ciphertext homomorphically to generate the one or more rotation keys. The R-LWE ciphertext encrypts a polynomial having the set of coefficients of the secret key polynomial; a given rotation key corresponds to rotated coefficients of that polynomial. The generated rotation keys are useful for FHE computation.

### BACKGROUND OF THE INVENTION

### Technical Field

This disclosure relates generally to the use of homomorphic encryption operations to facilitate computing against encrypted data.

### Background of the Related Art

Homomorphic Encryption (HE) is a form of encryption that allows computations to be carried out on ciphertexts, thus generating an encrypted result which, when decrypted, “matches” the result of operations performed on the plaintext. A homomorphic encryption scheme is a cryptosystem that allows computations to be performed on data without decrypting it.

The first plausible fully homomorphic encryption (FHE) scheme was introduced by Craig Gentry from IBM® Research in 2009. Until then it was not possible to perform an arbitrary amount of multiplication and addition operations on encrypted data due to the inherent growth of “noise” in the ciphertext after each compute operation, effectively reaching a point in which the ciphertext can no longer be decrypted. FHE is built on sound mathematical constructs, specifically lattice-based (e.g., Learning With Errors (LWE)) problems. These problems are universally considered difficult to solve without any known efficient algorithms to do so. Although FHE has a symmetric-key function, it is mostly used as a public key cryptography scheme, where a secret private key is used to generate public and evaluation keys that can then be shared. The introduction of a “bootstrapping” mechanism by Gentry, which cleans and reduces the amount of “noise” in the ciphertext, opened the door for the ubiquitous use of FHE in industry. Novel and more efficient schemes have been developed since its introduction, such as the fourth-generation Cheon-Kim-Kim-Song (CKKS) scheme, which is useful for floating point calculations, like those used in machine learning algorithms. Traditional encryption schemes such as AES (Advanced Encryption Standard) and RSA (Rivest-Shamir-Adelman) provide strong cryptographical guarantees on the security of data at rest and in transit, but they do not address the critical protection of data while in processing. With FHE, data always remains encrypted at rest, in transit, and during processing. In Privacy-Preserving Machine Learning (PPML), and using FHE, an AI model can be trained using data it cannot “see” to produce a model that only the users who hold the secret key(s) can decrypt and manipulate.

While FHE provides end-to-end data security and privacy with strong cryptographic guarantees, secure computation between a client that holds a secret key and the server that performs the homomorphic operations is challenging. Because the homomorphic operations for encryption schemes such as CKKS are performed in a component-wise manner for an encrypted message vector, rotation operations for cyclic shifts of the encrypted message vector are required, e.g., to facilitate bootstrapping. These rotation operations require different rotation keys for different cyclic shifts. The standard way to generate rotation keys is to compute them in the client during scheme initialization. This computation, however, uses significant resources, and large network bandwidth is required to send the resulting rotation keys to the cloud. For example, a single rotation key may be 100 MB in length, and often twenty (20) or more such keys are needed in certain applications; in such case, the delivery of the rotation keys from the client to the cloud would consume 2 GB in network traffic.

To address the problem of excessive communication overhead, it has been suggested (Lee et al., “Hierarchical Galois Key Management Systems for Privacy Preserving AlaaS with Homomorphic Encryption”) to have the client produce fewer keys, and then have the server construct rotation keys from this smaller set. The drawback of this solution is that it still involves generating and transmitting a non-trivial number of rotation keys, as noted above a very resource-intensive process that also still requires significant communication and storage capability. This known approach also would not work well with CKKS, as it would consume several multiplication levels from the CKKS scheme, and thus reduce the performance of the homomorphic computations. In an alternative solution (Kim et al., “LFHE: Fully Homomorphic Encryption with Bootstrapping Key Size Less Than A Megabyte”), the client generates a set of blind rotation keys for a bitwise-based encryption scheme and packs them into much fewer RLWE ciphertexts that are then sent to the server, which later unpacks them back to the original blind rotation keys. This approach, like Lee, still requires significant local resources to generate the blind rotation keys, and it is only used for bitwise-based schemes.

### BRIEF SUMMARY

To address the above-described resource challenges, and in lieu of generating numerous rotation keys at the client and then sending those keys to the server where they can be used for the FHE computations, the approach herein involves the client generating a “master” key from a secret key known only to the client, and then sending that master key to the server where it is used to homomorphically generate the rotation keys. In one example embodiment, the client multiplies its secret key by a large prime number to generate a secret key polynomial having a set of coefficients. The client then encrypts each coefficient of the secret key polynomial as a Learning With Errors (LWE) ciphertext that contains, e.g., just a single coefficient. Preferably, the client also derives two (2) additional keys from the secret key polynomial, namely, a rotation key (e.g., by 1-step), and an LWE switch key, and it transmits the master key and these additional keys to a server where the rotation keys will be generated homomorphically. There, the server first uses the LWE switch key to expand (e.g., by inflating) the dimension of each LWE ciphertext in the master key to match a dimension (coefficient-wise) of one or more rotation keys that will be generated homomorphically. To generate a new rotation key, the server re-orders (e.g., by shuffling) each LWE ciphertext and, using the 1-step rotation key, packs the LWE ciphertexts to a single Ring Learning With Errors (R-LWE) ciphertext. The encrypted plaintext of the R-LWE ciphertext is a polynomial with coefficients that correspond to the set of coefficients in the secret key polynomial, and a given rotation key then corresponds to “rotated” coefficients of the secret key polynomial.

The foregoing has outlined some of the more pertinent features of the disclosed subject matter. These features should be construed to be merely illustrative. Many other beneficial results can be attained by applying the disclosed subject matter in a different manner or by modifying the subject matter, as will be described below.

### BRIEF DESCRIPTION OF THE DRAWINGS

For a more complete understanding of the subject matter herein and the advantages thereof, reference is now made to the following descriptions taken in conjunction with the accompanying drawings, in which:

FIG. 1 depicts an exemplary block diagram of a data processing system in which exemplary aspects of the illustrative embodiments may be implemented;

FIG. 2 is a representative Machine Learning as-a-service (MLaaS) operating environment in which the techniques of this disclosure may be implemented;

FIG. 3 depicts a client and server workflow for homomorphic generation of rotation keys according to this disclosure;

FIG. 4 depicts a client side of a rotation key generation workflow utilizing the techniques of this disclosure; and

FIG. 5 depicts a server side of the rotation key generation workflow.

### DETAILED DESCRIPTION OF AN ILLUSTRATIVE EMBODIMENT

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the rotation key generation code 200 of this disclosure. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

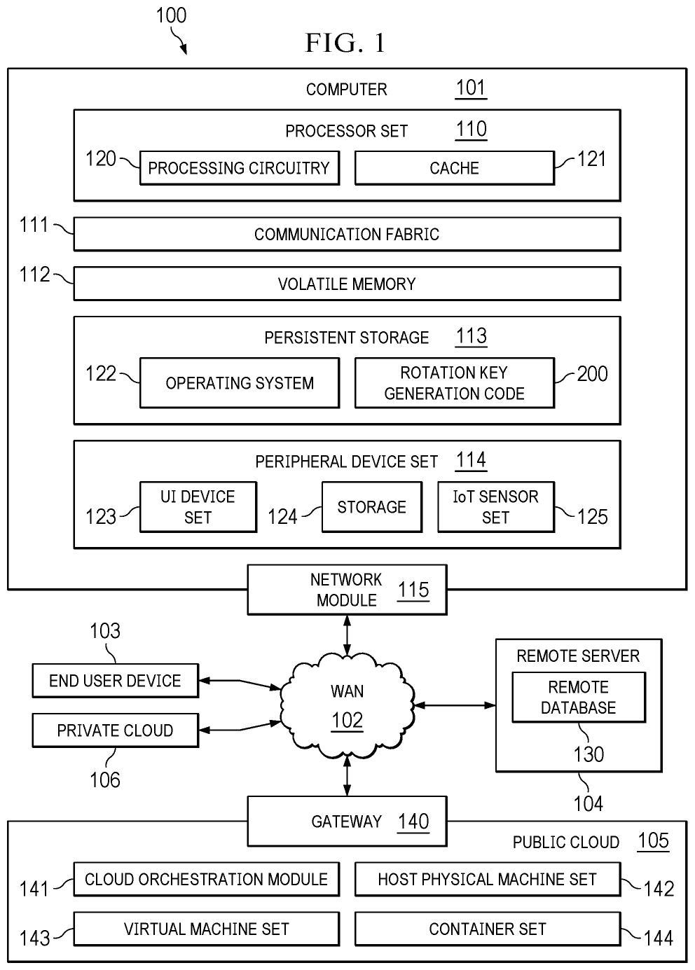

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor Set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication Fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile Memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent Storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as Linux, various known proprietary operating systems or open source Portable Operating System Interface-type operating systems that employ a kernel. The code included in block 200 typically includes at least some of the computer code involved in performing the inventive methods.

Peripheral Device Set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network Module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote Server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public Cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private Cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### Homomorphic Encryption

Homomorphic encryption (HE) is a public-key encryption scheme that in addition to the usual functions Enc, Dec (see below) also provides functions to perform operations on encrypted data (usually addition and multiplication). The encryption operation Enc: [symbol] ₁- [symbol] ₂ encrypts input plaintext from the ring [symbol] ₁(+,*) into ciphertexts in the ring [symbol] ₂(⊕,⊙), and its associated decryption operation is Dec:: [symbol] ₂→ [symbol] ₁. An HE scheme is correct if for every valid input x,y∈ [symbol] ₁:Dec(Enc (x))=x, Dec(Enc (x)⊕Enc (y))=x+y, and Dec(Enc (x)⊙Enc (y))=x*y, and is approximately correct (as in CKKS) if for some small ϵ>0 that is determined by the key, it follows that |x−Dec (Enc (x))|≤ϵ. The addition and multiplication equations are modified in the same way. For schemes that support SIMD (Single Instruction Multiple Data), additions and multiplications are applied slot-wise on vectors.

Several HE schemes have been proposed based on hardness of a computational problem known as Ring Learning with Errors (R-LWE). Prominent examples of such schemes include BFV (Brakerski/Fan-Vercauteren), BGV (Brakerski-Gentry-Vaikuntanathan), and CKKS (Cheon-Kim-Kim-Song) schemes, which schemes (named after the original proposers) are both additively and multiplicatively homomorphic. While the BFV and BGV schemes are efficient for vector operations over integers, the CKKS scheme is more appropriate for “approximate” (limited precision) floating-point operations.

Some HE schemes, such as CKKS, operate on ciphertexts in a homomorphic Single Instruction Multiple Data (SIMD) fashion. This means that a single ciphertext encrypts a fixed-size vector, and the homomorphic operations on the ciphertext are performed slot-wise on the elements of the plaintext vector. To utilize the SIMD feature, more than one input element is packed and encrypted in every ciphertext. This ciphertext packing enables parallelization of addition and multiplication operations. That said, the packing method used can dramatically affect the latency (i.e., time to perform computation), throughput (i.e., number of computations performed in a unit of time), communication costs, and memory requirements. Comparing numbers under HE and specifically CKKS often relies on polynomial approximations of the Step( ) or Sign( ) functions, whereas the accuracy and performance of these methods rely on the degrees of these polynomials. These comparison functions are denoted by Eq(x, y)≈1⇔x=y, and Eq≈0 otherwise.

More generally, homomorphic encryption enables the construction of programs for any desirable functionality, which can be run on encrypted inputs to produce an encryption of the result. Because such a program need never decrypt its inputs, it can be run by an untrusted party without revealing its inputs and internal state. Toolkits for implementing homomorphic encryption are known. A well-known toolkit is HElib, an open-source project. The current version of HElib supports addition and multiplication operations of arbitrary numbers in binary representation, using encryption of the individual bits.

By way of additional background, an LWE ciphertext is defined as follows for a plaintext space m∈ [symbol] _{q}, and with respect to a secret key s̅∈ [symbol] _{q}^{N}. Samples taken uniformly from [symbol] _{q}^{N} are represented by ā. The LWE ciphertext is (ā·s̅+m+e, ā)∈ [symbol] _{q}^{N+1}.

An R-LWE ciphertext is generated as follows. [symbol] := [symbol] [X]/Φ_{M}(X). For a message m and a secret key s, values of a, s, m, e∈ [symbol] _{q} for M are powers of 2 (in some HE schemes), a, s are sampled uniformly, and e is sampled with small coefficients. The R-LWE ciphertext is ct=(as+e+m, a)∈ [symbol] _{q}², where ct is the ciphertext of the message m with respect to secret key s, e.g., [symbol] ct, (1,−s) [symbol] =m+e mod q (for CKKS).

A rotation key is defined as follows. Let ϕ be a rotation function. A ciphertext of a rotated message ϕ(m) with respect to secret key ϕ(s) is then as follows:

$$ϕ ( c t ) = ( ϕ ( a * s + m + e ) , ϕ ( a ) ) = ( ϕ ( a ) ϕ ( s ) + ϕ ( m ) + ϕ ( e ) , ϕ ( a ) ) .$$

In order to continuing doing homomorphic computation, all ciphertexts are required to be with respect to the same secret key s, i.e., (ϕ(a)s+ϕ(m)+e,ϕ(a)). Rotation keys are used by a key switching method that transforms a ciphertext with respect to ϕ(s) secret key with respect to s. It has the following structure: SW K_{ϕ(s)→s}:=(a·s+P·ϕ(s)+e, a), where P is a large prime.

As described above, conventionally, standard rotation keys are generated on a client and then delivered to the server (more generally, the cloud), where those keys are then used to facilitate homomorphic operations, such as in a CKKS, BGV or other such word-based scheme. In a typical rotation key generation process, the client generates a secret key, which is a polynomial with random coefficients. To create the rotation keys, the client then rotates the secret key coefficients and encrypts the resulting polynomial with the secret key. As also noted, this process is very resource-intensive in terms of computation, network bandwidth and storage, and prior art solutions have not provided an adequate solution.

### Machine Learning-as-a-Service Using Homomorphic Encryption (ML Over HE)

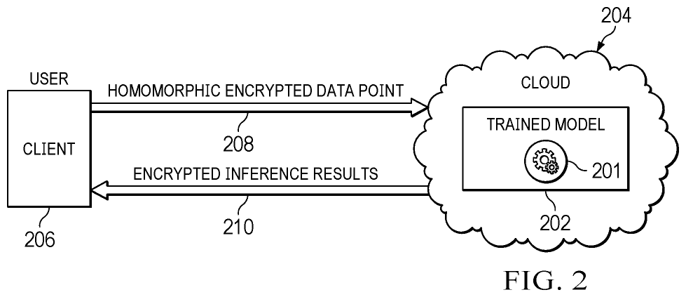

With reference now to FIG. 2, a representative (but non-limiting) operating environment for the technique herein is depicted. As shown, in a typical machine learning (ML) as a service scenario, a trained model such as a decision tree 201 is hosted on a cloud server 202 (sometimes referred to herein as Cloud) in a cloud computing infrastructure 204 such as described above. The model/tree (or other decision logic) 201 may be exposed as an Application Programming Interface (API) on the cloud 204. In operation, and as a service, the hosting cloud server 202 allows users to run inference queries on the model/tree 201. Typically, a user (sometimes referred to herein as Client) is associated with a client machine 206, and the client and server are configured to operate according to a client-server model. A homomorphic encryption (HE) protocol is enforced across the client-server operating environment such that the Cloud protects the model's privacy while users (Clients) maintain the privacy of their scoring data points returned by the model/tree. In a typical request-response workflow, the client 206 sends an encrypted query 208 (e.g., a data point) to the cloud server 202, the cloud server 202 applies the model/tree 201 and then returns a response 210. The response includes the encrypted inference results. In this manner, privacy-preserving inference problems are securely evaluated.

Thus, as depicted in FIG. 2, the Client homomorphically-encrypts its data points and shares them with the Cloud. In this example embodiment, the Cloud then uses the public key received from the Client to encrypt its model, and it homomorphically-evaluates the decision tree on the encrypted data points. In a variant embodiment, the Cloud does not need to encrypt its model before using it on inference on the encrypted data point supplied by the user. This is because CKKS (and other schemes) allow computations to be performed that involve both ciphertexts (like the user's data point) and plaintexts (e.g., the Cloud's model).

Generalizing, and as described above, PPML that use HE (sometimes referred to herein as ML over HE) typically involve two entities: a user (client), and a semi-honest cloud server that performs Machine Learning (ML) computation on HE-encrypted data. The user can train a model locally, encrypt it, and upload it to the cloud. In such a case, the model architecture and its weights are not considered a secret from the user, but only from the cloud. Alternatively, the user can ask the cloud to train a model on her/her behalf over encrypted/unencrypted data and, at a later stage, perform inference operations (again, on the user's behalf) using the trained model. In some scenarios, the model is a secret and should not be revealed to the user, who receives only the classification or prediction output (the result of the inferencing). It is assumed that all communications between all entities are encrypted using a secure network protocol, e.g., TLS 1.3, that provides confidentiality and integrity, and that allows the users to authenticate the cloud server.

Fully Homomorphic Encryption (FHE) (such as enabled by the CKKS scheme described above) allows data to remain encrypted during computation, regardless of the cloud or infrastructure used to process it.

### Homomorphic Generation of Rotation Keys

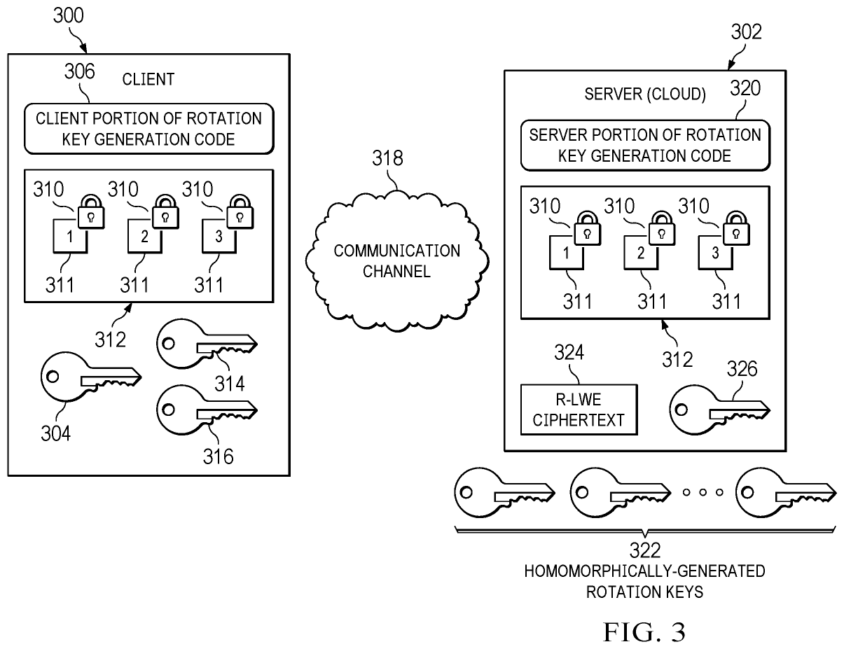

With the above as background, the following describes a technique for homomorphically generating rotation keys that obviates having the client generate all of the rotation keys required for homomorphic operations on the server or the requirement for the client to send multiple large rotation keys to the server. Instead, the technique herein provides for server-based homomorphic generation of the rotation keys directly, using only a small set of information provided by the client. FIG. 3 depicts the basic workflow involving a client 300, and a server 302. As noted above, server 302 corresponds generally to the cloud, i.e., the location where the homomorphic operations are intended to be carried out. As depicted, the client 300 possesses or generates a secret key 304, and it uses a first (client) portion 306 of rotation key generation code (code 200, in FIG. 1) to generate a set of Learning With Errors (LWE) ciphertexts 310 that together comprise a “master” key 312. A technique for generating the LWE ciphertexts is described above. According to the technique here, the set of LWE ciphertexts 310 are derived by the client 300 using the first portion 306 of the rotation key generation code with respect to a polynomial associated with the secret key 304. Typically, this polynomial comprises a set of coefficients (of the secret key) 311, and each LWE ciphertext 310 is derived from a particular one of those coefficients. Each LWE ciphertext 310 has a small size and typically includes just a single coefficient (e.g., “0,” “−1” or “+1”). As also depicted, the first portion 306 of the rotation key generation code also generates two (2) additional keys, namely a 1-step rotation key 314, and an LWE switch key 316. The master key 312 (comprising the LWE ciphertexts 310), the 1-step rotation key 314 and the LWE switch key 316 comprise the small set of information that is then sent to the server 302 over a communication channel 318. At the server, a second (server) portion 320 of the rotation key generation code receives this set of information and uses it to homomorphically generate a set of rotation keys 322 that are then useful for homomorphic operations on the server. As will be described in more detail below, the server portion 320 of the rotation key generation code accomplishes this by, among other things, processing the set of LWE ciphertexts 310 into a ring variant (R-LWE) ciphertext 324 homomorphically. This operation is sometimes referred to as LWE to R-LWE packing, and there are known algorithms that may be used (e.g., Chen et al., “Efficient Homomorphic Conversion Between (Ring) LWE Ciphertexts”). Advantageously, the R-LWE ciphertext encrypts a polynomial having coefficients of a secret key 326. A given rotation key 322 then corresponds to rotated coefficients of the secret key 326.

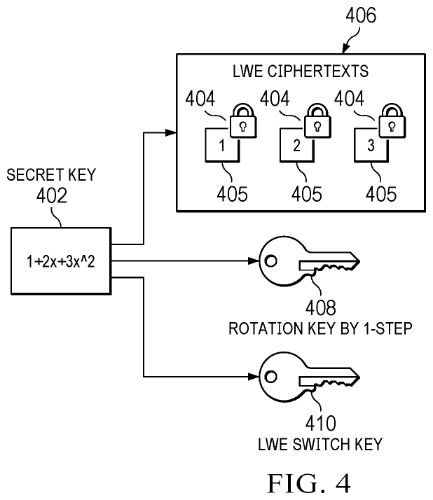

With reference now to FIG. 4, a more detailed view of the client-side operations is shown. In this embodiment, the client generates a secret key polynomial 402 (e.g., 1+2x+3x²) having a set of coefficients 405 (in this case, “1,” “2” and “3”). The client may possess the secret key polynomial or generate it as necessary. As depicted, the client encrypts the coefficients as a set of LWE ciphertexts 404 that together comprise the master key 406. In addition, and using the secret key polynomial, preferably the client also generates two (2) additional keys, namely, a 1-step rotation key 408 (i.e., a rotation key formed by rotating the set of coefficients by one step), and an LWE switch key 410. As will be described, keys 408 and 410 are used on the server-side to facilitate processing the LWE ciphertexts 404 into a ring variant (the R-LWE ciphertext) that is then used for the homomorphic generation of the actual rotation keys. Preferably, and on the client, the LWE dimension is chosen to be much smaller than the R-LWE dimension, as it is only necessary to encrypt a small range of values (e.g., −1, 0, 1). The resulting LWE ciphertext generated on the client side has a small size yet maintains the R-LWE scheme security level. As a consequence, only small bandwidth requirements for client data need to be maintained.

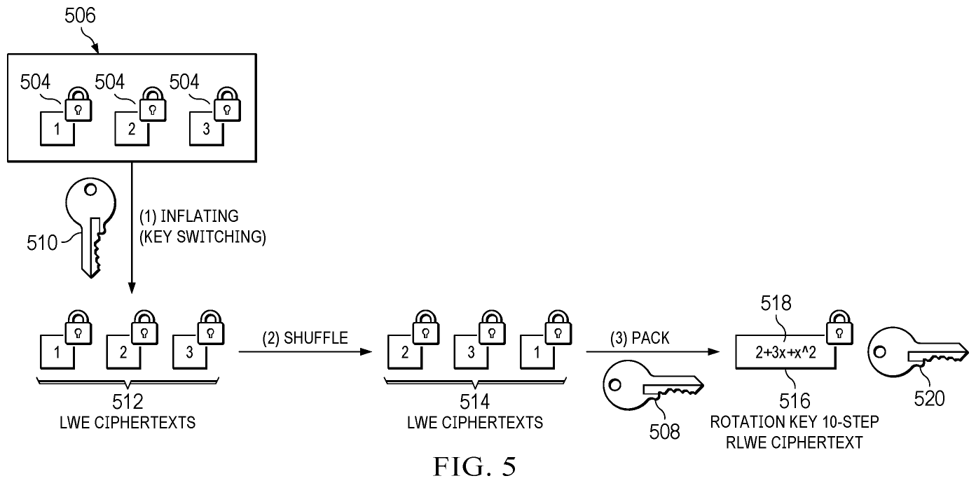

The processing on the LWE ciphertexts into the ring variant R-LWE ciphertext is depicted in FIG. 5, which is now described. As described below, these operations occur on a “server,” but the notion of a server is not intended to be limiting. Generalizing, and with respect to a “client-side,” these operations may be implemented “server-side,” which may extend to a conventional server, a cloud, an agent that is a component of a hardware accelerator that does the computation, another client (in a peer-to-peer configuration), any other mechanism or function that performs computations on a server's behalf, or the like. Regardless of how implemented, the operations begin by receiving the set of information generated at the client, namely, the master key 506 comprising the set of LWE ciphertexts 504, the single 1-step rotation key 508, and the LWE switch key 510. Using the LWE switch key 510, and at step (1), the server performs key switching on the master key, which inflates the dimension of each LWE ciphertext therein to match a desired dimension of the one or more (new) rotation keys that are to be homomorphically-generated. The expanded dimension is the same as a dimension of the rotation keys that are to be generated. The ciphertexts that result from the key switching operation are depicted at 512. At step (2), these ciphertexts are re-ordered (e.g., by shuffling) to produce shuffled LWE ciphertexts 514 that, at step (3), and using the 1-step rotation key 508, are packed into an R-LWE ciphertext 516 using a packing algorithm. This creates a secret key that will be used for homomorphic generation of the new rotation keys. In the depicted example, the R-LWE ciphertext 516 encrypts a polynomial 518 (in this example, the polynomial “2+3x+x²” after ten (10) rotations, each provided by the LWE ciphertext, having coefficients “2,” “3” and “1”) of an R-LWE secret key 520. The R-LWE secret key 520 shown in the drawing is merely representational, as it just includes coefficients that correspond to the coefficients of the secret key polynomial used on the client-side. A (new) FHE rotation key then corresponds to rotated coefficients of the secret key polynomial (shown here as R-LWE secret key 520), and depending on the number of rotations, there are one or more rotation keys generated. Each rotation key can be generated independently of any other rotation key, and a noise level associated with each such generated rotation key is constant.

Summarizing, and according to this server-side workflow, the dimension of the LWE ciphertexts (of the master key) are expanded to match a dimension of the required (new) rotation key, and the ciphertexts are then re-ordered and packed to a single R-LWE ciphertext. The encrypted plaintext of that ciphertext is a polynomial with “rotated” coefficients that correspond to the coefficients in the secret key polynomial and that were used to create the LWE ciphertexts on the client side. In this manner, the R-LWE ciphertext thus can be seen as a standard FHE rotation key for use in a word-based homomorphic scheme, such as CKKS, BGV, or the like.

One or more of the above-described operations in the cloud may be varied. For example, while use of the LWE switch key is a preferred technique to inflate the LWE ciphertext dimension to match that of the desired rotation key(s) (i.e., the R-LWE dimension), there are also other known methods to expand the dimension that may be utilized. In such case, it is not necessary for the client to generate and transmit the LWE switch key. As another variant, the 1-step rotation key generated on the client may have some other step value. Also, while re-ordering the coefficients of the LWE ciphertext by shuffling is a preferred technique, there are also other known methods to permute the LWE ciphertexts prior to applying the packing algorithm. The particular packing algorithm that is utilized is also not a limitation. Representative packing algorithms are described in Bae et al., “HERMES: Efficient Ring Packing Using MLWE Ciphertexts and Application to Transciphering,” and Chen et al. referenced above.

The approach herein provides significant advantages. By having the client generate LWE ciphertexts that can rearranged in the cloud and homomorphically pack to an R-LWE ciphertext that is equivalent to a required rotation key, there is no longer any requirement for the client to consume significant computing, storage and bandwidth to generate the rotation keys and deliver them to the cloud. The rotation keys necessary for homomorphic computations (e.g., in a scheme such as CKKS, BGV, or others) are generated homomorphically on the cloud, but without requiring access to the client's secret key. The approach provides for significant reduction in the number and size of the keys that are communicated over the network, especially with respect to the most commonly-used FHE schemes (CKKS and BGV). More generally, the subject matter herein enables the client to generate and transmit over the wire the single master key from which the cloud then generates all required rotation keys. This greatly enhances the efficiency of the underlying FHE scheme. Further, the method described herein may be generalized to key types other than rotation keys.

Generalizing, the rotation key generation method according to this disclosure may be implemented as a standalone approach, e.g., a software-based function executed by a processor, or it may be available as a managed service (including as a web service via a SOAP/XML interface). The particular hardware and software implementation details described herein are merely for illustrative purposes, and they are not meant to limit the scope of the described subject matter.

More generally, computing devices within the context of the disclosed subject matter are each a data processing system (such as shown in FIG. 1) comprising hardware and software, and these entities communicate with one another over a network, such as the Internet, an intranet, an extranet, a private network, or any other communications medium or link. The applications on the data processing system provide native support for Web and other known services and protocols including, without limitation, support for HTTP, FTP, SMTP, SOAP, XML, WSDL, UDDI, and WSFL, among others. Information regarding SOAP, WSDL, UDDI and WSFL is available from the World Wide Web Consortium (W3C), which is responsible for developing and maintaining these standards; further information regarding HTTP, FTP, SMTP and XML is available from Internet Engineering Task Force (IETF). Familiarity with these known standards and protocols is presumed.

As also depicted in FIG. 1, the scheme described herein may be implemented in or in conjunction with various server-side architectures including simple n-tier architectures, web portals, federated systems, and the like. The techniques herein may also be practiced in whole or in part in a loosely-coupled server (including a “cloud”-based) environment.

Still more generally, the subject matter described herein can take the form of an entirely hardware embodiment, an entirely software embodiment or an embodiment containing both hardware and software elements. In a preferred embodiment, the function is implemented in software, which includes but is not limited to firmware, resident software, microcode, and the like. Furthermore, as noted above, the analytics engine functionality can take the form of a computer program product accessible from a computer-usable or computer-readable medium providing program code for use by or in connection with a computer or any instruction execution system. For the purposes of this description, a computer-usable or computer readable medium can be any apparatus that can contain or store the program for use by or in connection with the instruction execution system, apparatus, or device. The medium can be an electronic, magnetic, optical, electromagnetic, infrared, or a semiconductor system (or apparatus or device). Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. The computer-readable medium is a tangible item.

In a representative embodiment, the HE system and the rotation key generation code are implemented in a special purpose computer, preferably in software executed by one or more processors. The software is maintained in one or more data stores or memories associated with the one or more processors, and the software may be implemented as one or more computer programs. Collectively, this special-purpose hardware and software comprises the system described above.

While the above describes a particular order of operations performed by certain embodiments of the disclosed subject matter, it should be understood that such order is exemplary, as alternative embodiments may perform the operations in a different order, combine certain operations, overlap certain operations, or the like. References in the specification to a given embodiment indicate that the embodiment described may include a particular feature, structure, or characteristic, but every embodiment may not necessarily include the particular feature, structure, or characteristic.

Finally, while given components of the system have been described separately, one of ordinary skill will appreciate that some of the functions may be combined or shared in given instructions, program sequences, code portions, and the like.

As already mentioned, the techniques disclosed herein are not limited to any particular homomorphic encryption protocol such as CKKS, but this will be a typical implementation. More generally, the approach herein may be implemented in CKKS, any CKKS derivative, or in any similar HE scheme that supports real values with scaling.

The techniques herein provide for improvements to another technology or technical field, namely, homomorphic inferencing systems, as well as improvements to the operational capabilities of such systems when used in the manner described.

The nature of the data that is subject to the homomorphic inferencing is dependent on the application and is not intended to be limited. Example data types include financial, medical, genomic, measurement data, testing data, and so forth.

Having described the subject matter, what is claimed is as follows:

1. A method operating at a server for homomorphically generating one or more rotation keys useful for homomorphic computation, comprising:
receiving a set of Learning With Errors (LWE) ciphertexts, the set of LWE ciphertexts having been derived at a client with respect to a secret key polynomial, the secret key polynomial having a set of coefficients, each LWE ciphertext having been derived from a coefficient of the secret key polynomial and having a single coefficient; and
processing the set of LWE ciphertexts into a ring variant (R-LWE) ciphertext homomorphically to generate the one or more rotation keys, the R-LWE ciphertext encrypting a polynomial having the set of coefficients of the secret key polynomial, and wherein a given rotation key corresponds to rotated coefficients of the secret key polynomial.

2. The method as described in claim 1 wherein, prior to processing, a dimension of each LWE ciphertext is expanded to match a dimension of the R-LWE ciphertext.

3. The method as described in claim 2 wherein the dimension of each LWE ciphertext is expanded using a switch key received at the server, the switch key having been derived at the client from the secret key polynomial.

4. The method as described in claim 2 wherein processing the set of LWE ciphertexts comprises re-ordering the LWE ciphertexts, and packing the re-ordered LWE ciphertexts using a packing algorithm to generate the R-LWE ciphertext.

5. The method as described in claim 4 wherein the re-ordered LWE ciphertexts are packed using a key received at the server, the key having been derived at the client from the secret key polynomial.

6. The method as described in claim 1, further including performing a homomorphic computation using the one or more rotation keys.

7. An apparatus, comprising:
a processor;
computer memory holding computer program instructions executed by the processor to homomorphically generate one or more rotation keys useful for homomorphic computation, the computer program instructions comprising program code configured to:
receive a set of Learning With Errors (LWE) ciphertexts, the set of LWE ciphertexts having been derived at a client with respect to a secret key polynomial, the secret key polynomial having a set of coefficients, each LWE ciphertext having been derived from a coefficient of the secret key polynomial and having a single coefficient; and
process the set of LWE ciphertexts into a ring variant (R-LWE) ciphertext homomorphically to generate the one or more rotation keys, the R-LWE ciphertext encrypting a polynomial having the set of coefficients of the secret key polynomial, and wherein a given rotation key corresponds to rotated coefficients of the secret key polynomial.

8. The apparatus as described in claim 7 wherein the program code is further configured to expand a dimension of each LWE ciphertext to match a dimension of the R-LWE ciphertext.

9. The apparatus as described in claim 8 wherein the dimension of each LWE ciphertext is expanded using a switch key received at the apparatus, the switch key having been derived at the client from the secret key polynomial.

10. The apparatus as described in claim 8 wherein the program code configured to process the set of LWE ciphertexts includes program code further configured to re-order the LWE ciphertexts, and pack the re-ordered LWE ciphertexts using a packing algorithm to generate the R-LWE ciphertext.

11. The apparatus as described in claim 10 wherein the re-ordered LWE ciphertexts are packed using a key received at the apparatus, the key having been derived at the client from the secret key polynomial.

12. The apparatus as described in claim 7, wherein the program code is further configured to perform a homomorphic computation using the one or more rotation keys.

13. A computer program product in a non-transitory computer readable medium, the computer program product holding computer program instructions that, when executed by one or more processors in a host processing system, homomorphically generate one or more rotation keys useful for homomorphic computation, the computer program instructions comprising program code configured to:
receive a set of Learning With Errors (LWE) ciphertexts, the set of LWE ciphertexts having been derived at a client with respect to a secret key polynomial, the secret key polynomial having a set of coefficients, each LWE ciphertext having been derived from a coefficient of the secret key polynomial and having a single coefficient; and
process the set of LWE ciphertexts into a ring variant (R-LWE) ciphertext homomorphically to generate the one or more rotation keys, the R-LWE ciphertext encrypting a polynomial having the set of coefficients of the secret key polynomial, and wherein a given rotation key corresponds to rotated coefficients of the secret key polynomial.

14. The computer program product as described in claim 13 wherein the program code is further configured to expand a dimension of each LWE ciphertext to match a dimension of the R-LWE ciphertext.

15. The computer program product as described in claim 14 wherein the dimension of each LWE ciphertext is expanded using a switch key received at the host processing system, the switch key having been derived at the client from the secret key polynomial.

16. The computer program product as described in claim 14 wherein the program code configured to process the set of LWE ciphertexts includes program code further configured to re-order the LWE ciphertexts, and pack the re-ordered LWE ciphertexts using a packing algorithm to generate the R-LWE ciphertext.

17. The computer program product as described in claim 16 wherein the re-ordered LWE ciphertexts are packed using a key received at the host processing system, the key having been derived at the client from the secret key polynomial.

18. The computer program product as described in claim 13, wherein the program code is further configured to perform a homomorphic computation using the one or more rotation keys.
